(19) United States
(12) Patent Application Publication
(10) Pub. No.: US 2018/0030914 A1
(43) Pub. Date: Feb. 1, 2018

(54) SYSTEM FOR DETERMINING PISTON RING WEAR

(71) Applicant: Caterpillar Inc., Peoria, IL (US)

(72) Inventors: Austin P. Roe, East Peoria, IL (US); Scott A. Thompson, Washington, IL (US); Anthony T. Petrou, Peoria, IL (US); Michael J. Campagna, Chillicothe, IL (US)

(73) Assignee: Caterpillar Inc., Peoria, IL (US)

(21) Appl. No.: 15/224,333

(22) Filed: Jul. 29, 2016

(51) Int. Cl. F02D 41/22; F02D 41/26; G01M 15/04

(52) U.S. Cl. CPC F02D 41/22; G01M 15/042; F02D 41/26; F02D 2041/228

(57) ABSTRACT

A machine may comprise a piston; a memory; and an electronic control module. The electronic control module may be configured to obtain information identifying a previous amount of wear of the piston ring and information identifying an initial dimension of a coating of the piston ring; determine a piston ring wear rate based on a cylinder pressure associated with the piston; determine an amount of time between a current time and a time when the previous wear of the piston ring was calculated; calculate a current amount of wear of the piston ring based on the previous amount of wear of the piston ring, the amount of time, and the piston ring wear rate; calculate an amount of damage to the piston ring based on the current amount of wear and the initial dimension; and take a remedial action when the amount of damage exceeds a threshold.

### TECHNICAL FIELD

The present disclosure relates generally to a system for determining piston damage and, more particularly, to a system for system for monitoring and determining piston ring wear and for determining an amount of damage to the piston ring based on the piston ring wear.

### BACKGROUND

An internal combustion engine may include an engine block defining a plurality of cylinder bores, a crankshaft rotatably supported in the engine block, and pistons connected to the crankshaft and configured to reciprocate within the cylinder bores. Typically, each piston may include a skirt pivotally connected to the crankshaft, and a crown connected to a distal end of the skirt. A combustion bowl may be formed on an end face of the crown to receive injected fuel, and annular grooves may be formed in an outer surface of the crown to receive associated rings. A cooling passage may be annularly formed inside the crown, between the bowl and the cooling passage, to circulate engine oil that may cool the bowl.

The crown may include grooves and the grooves may receive piston rings. In this regard, a top piston ring (one of the piston rings) may seal combustion gases from a crankcase that houses the crankshaft. A portion of the top piston ring may include a coating that may help seal the combustion gases from the crankcase. Over a period of time, cylinder pressure (e.g., resulting from movement the piston) may act on the top piston ring and cause wear of the coating. As the coating wears, the top piston ring may wear. Wear of the top piston ring may reduce the seal and enable excessive blowby of combustion gases into the crankcase, thereby compromising oil quality.

U.S. Patent Application Publication No. 20150345421 (hereinafter the '421 publication) is directed to a piston of an internal combustion engine. The piston may include a piston crown with annular grooves, a combustion chamber bowl, and a piston skirt with a pin bore to receive a pin. However, the '421 publication does not disclose monitoring wear of a piston ring.

### SUMMARY

In some embodiments, a control system, monitoring an amount of wear of a piston ring of a piston of an engine, may comprise a sensor configured to detect a cylinder pressure associated with the piston; a memory configured to store piston ring wear information; and an electronic control module. The electronic control module may be configured to: obtain, from the piston ring wear information stored in the memory, information identifying a previous amount of wear of the piston ring and information identifying an initial thickness of a coating of the piston ring; determine a piston ring wear rate based on the cylinder pressure; determine an amount of time between a current time and a time when the previous wear of the piston ring was calculated; calculate a current amount of wear of the piston ring based on the previous amount of wear of the piston ring, the amount of time, and the piston ring wear rate; calculate an amount of damage to the piston ring based on the current amount of wear of the piston ring and the initial thickness; and take a remedial action based on the amount of damage to the piston ring.

In some embodiments, a method, for monitoring an amount of wear of a piston ring of a piston of an engine, may comprise detecting, by a sensor, a cylinder pressure associated with the piston; obtaining, by an electronic control module and from piston ring wear information stored in a memory, information identifying a previous amount of wear of the piston ring and information identifying an initial thickness of a coating of the piston ring; determining, by the electronic control module, a piston ring wear rate based on the cylinder pressure; determining, by the electronic control module, an amount of time between a current time and a time when the previous wear of the piston ring was calculated; calculating, by the electronic control module, a current amount of wear of the piston ring based on the previous amount of wear of the piston ring, the amount of time, and the piston ring wear rate; calculating, by the electronic control module, an amount of damage to the piston ring based on the current amount of wear of the piston ring and the initial thickness; and taking, by the electronic control module, a remedial action based on the amount of damage to the piston ring.

In some embodiments, a machine may comprise a piston; a memory configured to store piston ring wear information; and an electronic control module. The electronic control module may be configured to: obtain, from the piston ring wear information stored in the memory, information identifying a previous amount of wear of the piston ring and information identifying an initial dimension of a coating of the piston ring; determine a piston ring wear rate based on a cylinder pressure associated with the piston; determine an amount of time between a current time and a time when the previous wear of the piston ring was calculated; calculate a current amount of wear of the piston ring based on the previous amount of wear of the piston ring, the amount of time, and the piston ring wear rate; calculate an amount of damage to the piston ring based on the current amount of wear of the piston ring and the initial dimension; and take a remedial action when the amount of damage to the piston ring exceeds a piston ring damage threshold.

### BRIEF DESCRIPTION OF THE DRAWINGS

FIG. 1 is a cross-sectional view of an engine according to an embodiment of the present disclosure;

FIG. 2A is a cross-sectional view of a piston of the engine of FIG. 1;

FIG. 2B is another cross-sectional view of the piston of FIG. 2A with a piston ring;

FIG. 2C is a cross-sectional view of the piston ring of FIG. 2B;

FIG. 2D is another cross-sectional view of the piston ring of FIG. 2B;

FIG. 3 is a diagram of example components of a system that may be used to monitor and determine wear of the piston ring of FIG. 2B to determine damage to the piston ring; and

FIG. 4 is a flow chart of an example process performed by the system of FIG. 3 for monitoring and determining wear of the piston ring of FIG. 2B to determine damage to the piston ring.

### DETAILED DESCRIPTION

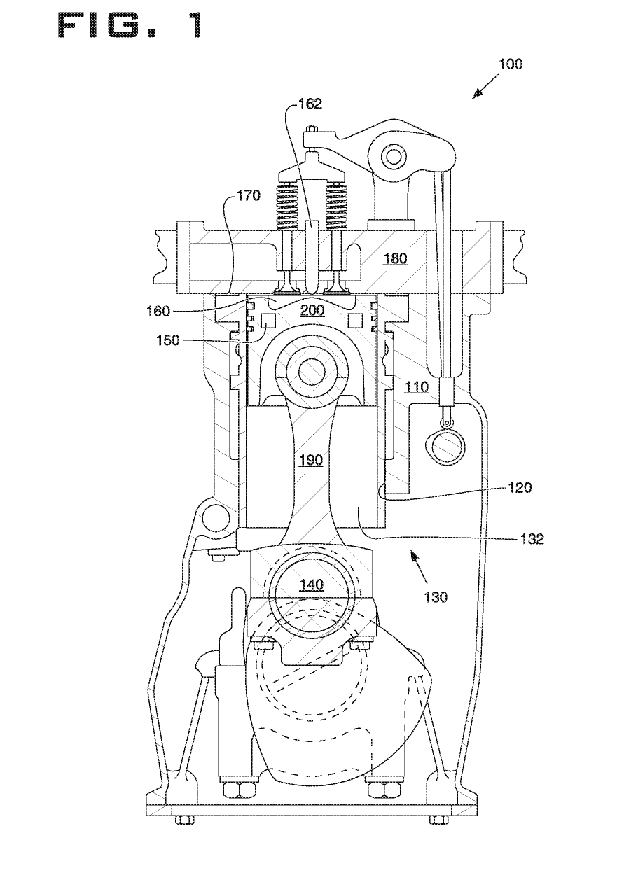

FIG. 1 is a cross-sectional view of an exemplary internal combustion engine 100 (or engine 100) according to an embodiment of the present disclosure. In some implementations, engine 100 may include a block 110 (or engine block 110) defining one or more bores 120 (or cylinder bores 12). A hollow liner 130 (or cylinder liner 130) may be disposed within each of the one or more bores 120, and a head 180 (or cylinder head 180) may be connected (e.g., by way of a gasket 170) to block 110 to close off an end of a bore 120, of the one or more bores 120, and cylinder liner (or liner) 130. A piston 200 may be slidably disposed within liner 130, and piston 200 together with liner 130 and head 180 may define a combustion chamber 160. Piston 200 may include an annular cooling passage 150. Piston 200 and annular cooling passage 150 are described in more detailed below. In some implementations, engine 100 may include one or more combustion chambers 160 and the one or more combustion chambers 160 may be disposed in an “in-line” configuration, in a “V” configuration, in an opposing-piston configuration, or in any other suitable configuration.

In some implementations, piston 200 may be configured to reciprocate within liner 130 between a top-dead-center (TDC) position and a bottom-dead-center (BDC) position during a combustion event occurring with chamber 160. More particularly, piston 200 may be pivotally connected to a crankshaft 140 by way of a connecting rod 190 (or rod 190), so that a sliding motion of each piston 200 within cylinder liner 130 results in a rotation of crankshaft 140. Similarly, a rotation of crankshaft 140 may result in a sliding motion of piston 200. In a four-stroke engine, piston 200 may move through four full strokes to complete a combustion cycle of about 720° of crankshaft rotation. These four strokes include an intake stroke (TDC to BDC), a compression stroke (BDC to TDC), a power stroke (TDC to BDC), and an exhaust stroke (BDC to TDC). Fuel (e.g., diesel fuel, gasoline, gaseous fuel, etc.) may be injected into combustion chamber 160 during the intake stroke. The fuel may be mixed with air and ignited during the compression stroke. Heat and pressure resulting from the fuel/air ignition may then be converted to useful mechanical power during the ensuing power stroke. Residual gases may be discharged from combustion chamber 160 during the exhaust stroke.

The number of components (of engine 100) shown in FIG. 1 is provided for explanatory purposes. In practice, there may additional components, fewer components, different components, or differently arranged components than those shown in FIG. 1.

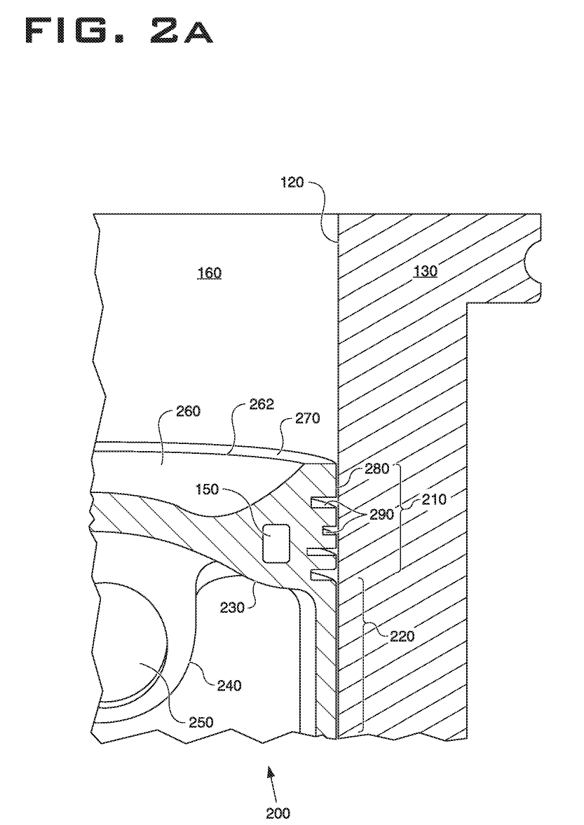

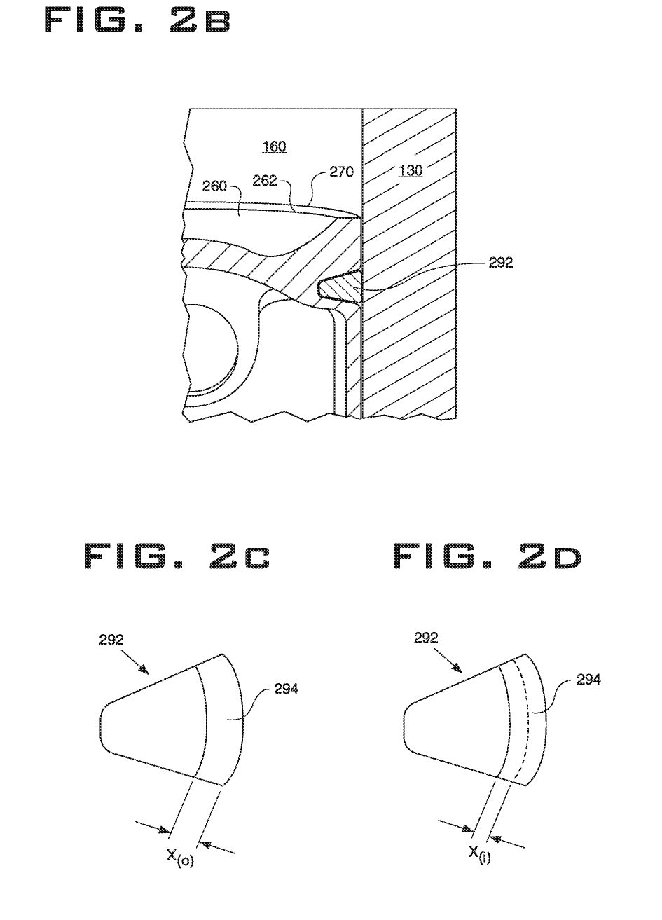

FIG. 2A is a cross-sectional view of piston 200 of engine 100 of FIG. 1. In some implementations, piston 200 may generally consist of an integral crown 210 (or crown 210), a skirt 220, and undercrown 230. Skirt 220 be generally tubular (i.e., hollow and cylindrical), with a bearing support 240 (or support 240) formed therein. Support 240 may be configured to receive a wrist pin that pivotally connects piston 200 to rod 190 (referring to FIG. 1). Support 240 may define a pin bore 250. Piston pin bore (or piston bore) 250 may receive a piston pin (not shown). Crown 210 may be formed at end of piston 200 opposite support 240, and may include an end face 270 and an annular side surface 280. Undercrown 230 may correspond to an area under crown 210. One or more ring grooves 290 may be cut into annular side surface 280 and configured to receive corresponding oil rings (not shown), compression rings (not shown), or another type of piston ring known in the art. A bowl 260 may be recessed within end face 270, and a rim 262 (bowl rim 262) may be located at an intersection of bowl 260 and end face 270. An annular cooling passage 150 may be formed in crown 210 between bowl 260 and grooves 290. The circulation of engine oil or another coolant through passage 150 during operation of engine 100 may reduce a temperature of crown 210. In some implementations, annular cooling passage 150 may define (or may correspond to) an oil gallery in which the engine oil may reside. With this configuration, the engine oil may function as a heat sink, causing combustion heat from inside bowl 260 to pass radially outward and downward in a direction toward annular cooling passage 150.

FIG. 2B is another cross-sectional view of piston 200 of FIG. 2A with a piston ring 292. As illustrated in FIG. 2B, one (or more) of grooves 290 may receive piston ring 292. In some implementations, piston ring 292 may be a top piston ring of piston 200. Alternatively, piston ring 292 may be another piston ring of piston 200.

FIG. 2C is a cross-sectional view of piston ring 292 of FIG. 2B. Is illustrated in FIG. 2C, a portion of piston ring 292 may include a coating 294. In some implementations, coating 294 may have an initial dimension (e.g., an initial thickness X(0)) when piston ring 292 is first provided on one of grooves 290.

FIG. 2D is another cross-sectional view of the piston ring of FIG. 2B. As illustrated in FIG. 2D, coating 294 of piston ring 292 may wear over a period of time due cylinder pressure and cylinder force (e.g., based on piston 200 sliding up and down cylinder bore 120 and cylinder liner 130) and piston ring 292 may wear accordingly. In some implementations, a pattern of wear of coating 294 may be from an outer surface of piston ring 292 toward an inner surface of piston ring 292, as illustrated in FIG. 2D. In this regard, the thickness of coating 294 may be reduced (e.g., X(i)) over the period time as coating 294 experiences wear over the period of time. Accordingly, when coating 294 is worn out (e.g., when the thickness of coating 294 is zero), piston ring 292 may be damaged and may cause other components of piston 200 and/or engine 100 to experience a failure. In some implementations, an amount of wear of piston ring 292 may be based on an amount of reduction of the initial dimension of coating 294.

The number of components shown in FIGS. 2A-2D is provided for explanatory purposes. In practice, there may additional components, fewer components, different components, or differently arranged components than those shown in FIGS. 2A-2D. Additionally, the shape of piston ring 292 is provided as example shapes. In some implementations, the shape of piston ring 292 may be rectangular, may have tapers, or other unique geometry. Additionally, or alternatively, coatings may not only exist on the outer face (i.e. radial wear). Instead, coatings may also exist on the axial face of piston ring 292. In this regard, as piston ring 292 moves up and down vertically in the groove, piston ring 292 may experience wear.

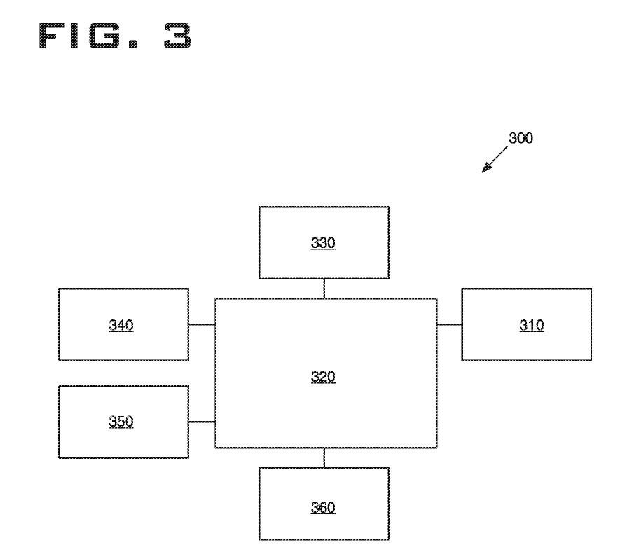

FIG. 3 is a diagram of example components of a system 300 that may be used to monitor and determine wear of piston ring 292 of FIG. 2B to determine damage to piston ring 292. In some embodiments, the example components may include a memory 310, an electronic control module (ECM) 320, a display 330, a sensor 340, an input device 350, and a communication interface 360. The example components of system 300 may be implemented using hardware, software, and/or a combination of hardware and software. In some implementations, the example components of system 300 may be interconnected using wired connections, wireless connections, and/or a combination of wired connections and wireless connections.

In some implementations, engine 100 and one or more of the example components of system 300 may be included in a machine. For example, engine 100, memory 310, ECM 320, display 330, sensor 340, input device 350 and/or communication interface 360 may be located in the machine. In some implementations, one or more of the example components of system 300 may be included in a back office. For example, memory 310, ECM 320, display 330, sensor 340, input device 350 and/or communication interface 360 may be located in the back office while engine 100 and sensor 340 may be located in the machine.

Memory 310 may include a random access memory (“RAM”), a read only memory (“ROM”), and/or another type of dynamic or static storage device (e.g., a flash, magnetic, or optical memory) that stores information and/or instructions for use by the example components, such as ECM 320, to monitor and determine wear of piston ring 292 of FIG. 2B to determine damage to piston ring 292. Additionally, or alternatively, memory 310 may include non-transitory computer-readable medium or memory, such as a disc drive, flash drive, optical memory, read-only memory (ROM), or the like. In some implementations, with respect to the information and/or the instructions for use by the example components, memory 310 may store information (e.g., obtained in real-time or near real-time by sensor 340) regarding temperature(s) of engine 100, temperature(s) of piston 200, temperature(s) of components of piston 200 (e.g., temperature(s) of crown 210, rim 262, undercrown 230, etc.). Additionally, or alternatively, memory 310 may store information regarding one or more models as described in U.S. patent application Ser. No. 15/087,439 (incorporated herein by reference in its entirety). For example, the one or more models may include a combustion model, a heat flux model, a thermal model, and/or a damage model. In some implementations, memory 310 may store the information and/or the instructions in one or more data structures, such as one or more databases, tables, lists, trees, etc.

ECM 320 (or controller 320) may include any type of device or any type of component that may interpret and/or execute the information and/or the instructions stored within memory 310 to perform one or more functions. For example, ECM 320 may use the information and/or execute the instructions to monitor and determine wear of piston ring 292 to determine damage to piston ring 292 and/or components of piston 200. In some implementations, ECM 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.), and/or any other hardware and/or software.

In some embodiments, ECM 320 may obtain information from the example components and use the information to monitor and determine wear of piston ring 292 to determine damage to piston ring 292 and/or piston 200. For example, ECM 320 may obtain information from sensor 340 and/or from memory 310 and use the information to monitor and determine wear of piston ring 292 to determine damage to piston ring 292 and/or piston 200. In some implementations, ECM 320 may transmit, via a network (not shown), information regarding the wear of piston ring 292 and/or information regarding the damage to piston 200 to another device (e.g., at a back office system (not shown)) and/or another machine (not shown)). For example, ECM 320 may cause communication interface 360 to transmit the information regarding the wear of piston ring 292 and/or information regarding the damage to piston 200.

Display 330 may include any type of device or any type of component that may display information. For example, display 330 may display information regarding the wear of piston ring 292 and/or information regarding the damage to piston 200. In some implementations, display 330 may be a liquid crystal display (LCD), a light-emitting diode (LED) display, an organic light-emitting diode (OLED) display, and/or the like.

Sensor 340 may include any type of device(s) or any type of component(s) that may sense (or detect) information regarding engine 100 and/or piston 200. In some implementations, sensor 340 may located at various portions of engine 100 and/or piston 200 to sense (or detect) information regarding engine 100 and/or piston 200. For example, the information regarding engine 100 and/or piston 200 may include a speed of engine 100 (e.g., a rotational speed of crankshaft 140), a mass of engine 100 (e.g., component(s) of engine 100), an inertia load (e.g., based on the speed and/or the mass), a quantity of fuel being injected into combustion chamber 160 during each combustion cycle, a timing of the fuel being injected, a pressure of the fuel being injected, a flow rate of air entering combustion chamber 160 during each combustion cycle, a temperature of the air, a pressure of the air, a temperature of the engine oil in passage 150 (e.g., the oil gallery) and/or other fluid of engine 100, a temperature of other components of engine 100 and/or piston 200 (e.g., crown 210, rim 262, etc.), a cylinder pressure (e.g., as piston 200 slides up and down cylinder bore 120 and cylinder liner 130) associated with piston 200, a cylinder force, a cylinder pressure load, and/or the like. In some implementations, sensor 340 may include a pressure sensor (e.g., to detect machine strut pressures), a force gauge, a load cell, a piezoelectric sensor, and/or the like.

Input device 350 may include a component that permits a user to input information to one or more other components of the example components of system 300. For example, the information, input by the user, may include a preference (of the user) for a frequency for monitoring and/or for determining the wear of piston ring 292 and the damage to piston 200. Additionally, or alternatively, the information, input by the user, may include a manner (e.g., algorithm(s), parameters(s), etc.) for monitoring and/or determining the wear of piston ring 292 and/or the damage to piston 200. In some embodiments, input device 360 may include a keyboard, a keypad, a mouse, a button, a camera, a microphone, a switch, a touch screen display, and/or the like.

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

The number of components shown in FIG. 3 is provided for explanatory purposes. In practice, there may additional components, fewer components, different components, or differently arranged components than those shown in FIG. 3.

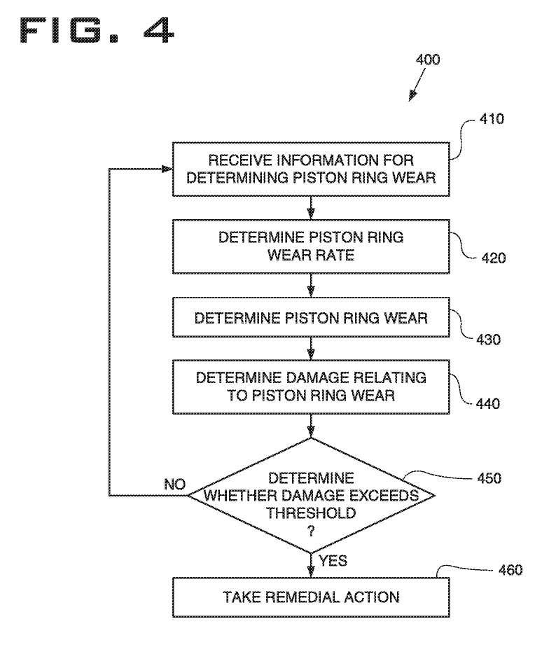

FIG. 4 is a flow chart of an example process 400 performed by the system of FIG. 3 for monitoring and determining wear of the piston ring of the piston of FIG. 2 to determine damage to the piston ring and/or the piston. In some implementations, one or more process blocks of process 400 may be performed by ECM 320. For example, ECM 320 may perform one or more process blocks of process 400 automatically (e.g., without intervention/input from a user). In some implementations, one or more process blocks of FIG. 4 may be performed by another device or a group of devices separate from or including ECM 320, such as device(s) at a remote location (e.g., a back office).

As shown in FIG. 4, process 400 may include receiving information for determining wear of piston ring 292 (block 410). For example, ECM 320 may receive piston ring wear information that ECM 320 may use with respect to determining the wear of piston ring 292. In some implementations, the piston ring wear information may be stored in memory 310 and ECM 320 may obtain the piston ring wear information from memory 310. Additionally, or alternatively, the piston ring wear information may be stored in another memory (similar to or different than memory 310) and ECM 320 may obtain the piston ring wear information from memory 310. Additionally, or alternatively, the piston ring wear information may be submitted by a user using input device 350 and ECM 320 may receive the piston ring wear information submitted by the user. Additionally, or alternatively, the piston ring wear information may be obtained by sensor 340 and ECM 320 may obtain the piston ring wear information from sensor 340.

In some implementations, the piston ring wear information may include an indication that wear is to be determined for piston 200. For example, the indication may submitted by a user using input device 350 and ECM 320 may receive the indication. Additionally, or alternatively, ECM 320 may obtain information from memory 310 and may identify the indication based on the information obtained from memory 310. In some implementations, the information from memory 310 may include a time interval for ECM 320 to determine the wear of piston ring 292. For example, the time interval may indicate that ECM 320 is to determine the wear of piston ring 292 at a frequency 0.01 Hz to 100 Hz. The time interval may be expressed in other units of time measurement. For example, the time interval may indicate that ECM 320 is to determine the wear of piston ring 292 every second, every minute, every hour, and/or the like.

Additionally, or alternatively, the piston ring wear information may include information identifying an initial dimension of coating 294 (e.g., when piston ring 292 is first installed on one of grooves 290). For example, the initial dimension of coating 294 may include an initial thickness of coating 294. In some implementations, ECM 320 may use the initial thickness of coating 294 to determine an amount of damage to piston ring 292 based on the wear of coating 294. For example, ECM 320 may determine a level of damage to piston ring 292 based on the wear of coating 294 with respect to the initial thickness (as will be explained in more detail below). In some implementations, the initial thickness may be different for each piston ring (e.g., based on physical parameters of piston ring 292, such as geometry, shapes, sizes, contours, material properties such as coefficients of heat transfer, etc.).

Additionally, or alternatively, the piston ring wear information may include piston and/or engine information regarding the components of piston 200 and/or the components of engine 100. For example, the piston and/or engine information may include the cylinder pressure and the cylinder force (e.g., obtained in real-time or near real-time by sensor 340). Additionally, or alternatively, the piston and/or engine information may include physical parameters (e.g., geometry, shapes, sizes, contours, material properties such as coefficients of heat transfer, etc.) of the components, relationships (e.g., a compression ratio, a bore stroke, valve timings, etc.) between the components, and/or the like. Additionally, or alternatively, the piston and/or engine information may include information regarding various fluids (fuel, lubrication, coolant, engine oil, air, etc.) of piston 200 and/or engine 100. For example, the information regarding various fluids may include a makeup of the fluids, a concentration of the fluids, a quality of the fluids, other characteristics of the fluids, and/or the like.

As further show in FIG. 4, process 400 may include determining a piston ring wear rate (block 420). For example, ECM 320 may calculate the piston ring wear rate of piston ring 292 based on the piston ring wear information. For instance, ECM 320 may determine the piston ring wear rate of piston ring 292 based on one or more factors, including the cylinder pressure and/or the cylinder force (e.g., obtained by sensor 340 and/or included in piston ring wear information). In some implementations, ECM 320 may determine a relationship between cylinder pressures and piston ring wear rates. In some implementations, the relationship between the cylinder pressures and the piston ring wear rates may be based on one or more experiments, field studies, analyses, simulations for one or more different coatings and/or the like. For example, results of the one or more analyses, experiments, field study, and/or the like may identify a corresponding piston ring wear rate for each cylinder pressure. For instance, the results may be illustrated as a graph (or a chart) that identifies a corresponding piston ring wear rate for each cylinder pressure. Accordingly, based on the cylinder pressure and using the relationship between the cylinder pressures and the piston ring wear rates, ECM 320 may determine the piston ring wear rate corresponding to the cylinder pressure.

In some implementations, the piston ring wear rate may be measured (or expressed) in micro meters per hour (μm/h). Additionally, or alternatively, other units of measurement may be used to measure (or express) the piston ring wear rate. In some implementations, the piston ring wear rate may vary (or change) over period of time based on a change in the (current) thickness of coating 294 (e.g., based on a reduction in the thickness of coating 294). For example, the piston ring wear rate may decrease as the thickness of coating 294 is reduced. Accordingly, ECM 320 may re-determine the piston ring wear rate each time ECM 320 determines the wear of piston ring 292. In some implementations, piston ring wear rates may vary based on physical characteristics of piston rings (e.g., properties, geometry, shape, etc.). In some implementations, the piston ring wear rate may vary based on other dimension of coating 294.

In some implementations, ECM 320 may calculate an effective piston ring wear rate based on the piston ring wear rate (calculated in block 420) and one or more factors, such as a wear rate modifier. In some implementations, the wear rate modifier may be based on an amount of time since start up of engine 100, a start and a stop frequency of engine 100, a load ramp rate (e.g., information regarding a load of engine 100 upon start up), and/or the like. Additionally, or alternatively, the wear rate modifier may be based on oil temperature, oil degradation/quality, and/or the like. In some implementations, information regarding the amount of time since start up of engine 100, the start and the stop frequency of engine 100, the load ramp rate, the oil temperature, and/or the oil degradation/quality may be included in the information regarding engine 100 and/or piston 200 obtained by sensor 340. In some implementations, ECM 320 may determine the wear rate modifier. In some implementations, ECM 320 may obtain the wear rate modifier from the piston ring wear information.

In some implementations, ECM 320 may calculate the effective piston ring wear rate based on a mathematical combination of the piston ring wear rate (or base piston ring wear rate) and the wear rate modifier. For example, ECM 320 may calculate the effective piston ring wear rate using the following equation:

\dot{X}(i)′=A*\dot{X}(i) EQ. 1
wherein:
   \dot{X}′ is the effective piston ring wear rate,
   i is the current iteration,
   A is the wear modifier, and
   \dot{X} is the base piston ring wear rate.

In some implementations, ECM 320 may update the piston ring wear information (stored in memory 310 and/or another memory) based on the piston ring wear rate (or the effective piston ring wear rate when calculated).

As further show in FIG. 4, process 400 may include determining piston ring wear (block 440). For example, ECM 320 may calculate the wear of piston ring 292 based on the piston ring wear rate (determined in block 420) or the effective piston ring wear rate (calculated in block 430) when calculated. In some implementations, ECM 320 may calculate the wear of piston ring 292 based on a mathematical combination of the piston ring wear rate (or the effective piston ring wear rate) and one or more other factors. For example, ECM 320 may calculate the wear of piston ring 292 using the following equation:

X(i)=X(i−1)+\dot{X}(i)*Δt EQ. 2
wherein:
   i is the current iteration (of the calculation of the wear of piston ring 292),
   X(i) is the wear of piston ring 292 (or the current wear of piston ring 292),
   X(i−1) is the previous wear of piston ring 292,
   \dot{X} is the piston ring wear rate, and
   Δt is the amount of time between a current time and a time (prior to the current time) when the previous wear of piston ring 292 was calculated (Δt may be based on or correspond to the time interval for ECM 320 to determine the wear of piston ring 292).

As explained above, the effective piston ring wear rate may be used instead of the piston ring wear rate (or base piston ring wear rate). As also explained above, an amount of wear of piston ring 292 may be based on an amount of reduction of the initial dimension of coating 294. In some implementations, the previous wear of piston ring 292 may refer to an amount of wear of piston ring 292 up until the time (prior to the current time) when the previous wear of piston ring 292 was calculated. In this regard, the piston pin bore 250 (or the current piston pin bore 250) may refer to an additional amount of wear of piston ring 292 up until the current time. In some implementations, information identifying the previous wear of piston ring 292 and information identifying the time when the previous wear of piston ring 292 was calculated may be included in the piston ring wear information. In this regard, ECM 320 may determine the current time as a time to calculate the wear of piston ring 292 based on the time interval and the time when the previous wear of piston ring 292 was calculated. For example, ECM 320 may determine that the time interval has elapsed since the time when the previous wear of piston ring 292 was calculated and, accordingly, determine that the wear of piston ring 292 is to be calculated at the current time. Additionally, or alternatively, ECM 320 may determine Δt based on the time interval and the time when the previous wear of piston ring 292 was calculated. Additionally, or alternatively, ECM 320 may determine Δt based on the current time and the time when the previous wear of piston ring 292 was calculated.

In some implementations, the wear of piston ring 292 may be measured (or expressed) in micro meters (μm). Additionally, or alternatively, other units of measurement may be used to measure (or express) the wear of piston ring 292. In some implementations, ECM 320 may update the piston ring wear information based on the wear of piston ring 292 (or the current wear of piston ring 292). For example, ECM 320 may update the previous wear of piston ring 292 with the current wear of piston ring 292. Accordingly, the current wear of piston ring 292, included in the piston ring wear information (stored in memory 310 and/or another memory), may become the previous wear of piston ring 292.

As further show in FIG. 4, process 400 may include determining damage relating to the wear of piston ring 292 (block 450). For example, ECM 320 may calculate an amount of damage to piston ring 292 based on the wear of piston ring 292 (determined in block 440) and the initial thickness (e.g., included in the piston ring wear information). In some implementations, ECM 320 may determine the amount of damage to piston ring 292 as a mathematical combination of the wear of piston ring 292 (determined in block 440) and the initial thickness. For example, ECM 320 may calculate the amount of damage to piston ring 292 using the following equation:

D=X(i)/X(0) EQ. 4
wherein:
   D is the amount of damage to piston ring 292,
   i is the current iteration (of the calculation of the current wear of piston ring 292),
   X(i) is the wear of piston ring 292 (or the current wear of piston ring 292), and
   X(0) is the initial thickness.

In some implementations, the amount of wear of piston ring 292 may be based on the amount of reduction of the initial dimension of coating 294 (e.g., the amount of reduction of the initial thickness of coating 294). In some implementations, the amount of damage to piston ring 292 may be expressed as a percentage (e.g., a percentage of the initial thickness). For example, assume the initial thickness of coating 294 is 20 μm. Further assume that the amount of wear of piston ring 292 (i.e., the amount of reduction of the initial thickness or amount of wear of coating 294) is 15 μm. Accordingly, the amount of damage to piston ring 292 would be 15 μm/20 μm or 75%. In this regard, ECM 320 may determine a level (or a percentage) of damage to piston ring 292 based on the calculated damage and may take remedial action if the level of damage meets and/or exceeds a threshold (as will be described in more detail below). Additionally, or alternatively, ECM 320 may determine that piston ring 292 is completely worn and damaged when the current thickness of coating 294 reaches zero. For example, ECM 320 may determine a failure of piston ring 292 when the thickness of coating 294 reaches zero.

In some implementations, the various equations and associated elements, described herein, to determine the amount of damage to piston ring 292 may form a piston damage model. In this regard, the various equations are provided as example equations. In some implementations, the associated elements (and/or additional elements) may be used in different mathematical combinations and/or different equations to determine the amount of damage to a piston ring. In some implementations, the piston damage model may be included in the piston ring wear information.

As further show in FIG. 4, process 400 may include determining whether the damage exceeds a threshold (block 450). For example, ECM 320 may determine whether the amount of damage to piston ring 292 (determined in block 440) exceeds a piston ring damage threshold. In some implementations, the piston ring damage threshold may correspond to an amount of wear of coating 294 that causes (or starts to cause) excessive blowby of exhaust gases into a crankcase of engine 100 (which house crankshaft 140), thereby compromising oil quality. In some implementations, the piston ring damage threshold may be included in the piston ring wear information. In some implementations, the piston ring damage threshold may be vary based on physical parameters of each piston ring.

As further shown in FIG. 4, if the damage exceeds the piston ring damage threshold (block 460—YES), then process 400 may include taking a remedial action (block 470). For example, if ECM 320 determines that the amount of damage to piston ring 292 (determined in block 450) exceeds the piston ring damage threshold, ECM 320 may take a remedial action. In some implementations, the remedial action may include causing information to be displayed via display 330. For example, the information may indicate that the amount of damage to piston ring 292 has exceeded the piston ring damage threshold and that piston 200 may be damaged and/or may fail if piston 200 continues to be used (or, in other words, if piston 200 is not replaced or serviced). Additionally, or alternatively, the information may indicate that engine 100 is to be shut down or derated to prevent additional wear and/or damage to piston ring 292, that engine 100 is to be serviced, that piston 200 is to be replaced or serviced, and/or the like. Additionally, or alternatively, the information may include instructions for servicing engine 100, instructions for servicing piston 200 (e.g., replacing and/or repairing piston 200), information identifying piston ring 292 and a location of piston ring 292 within engine 100 (for example, if engine 100 includes multiple pistons), and/or the like. In some implementations, the information may be transmitted to a remote location (e.g., a back office system) and/or another device. For example, ECM 320 may cause the information to be transmitted to the remote location and/or the other machine. In some implementations, the information may enable characteristics/attributes of a similar piston (e.g, properties, geometry, shape, etc.) to be modified during manufacture so as to reduce a wear rate of a piston ring during similar operating conditions.

Additionally, or alternatively, the remedial action may include causing service instructions to be provided. Additionally, or alternatively, the remedial action may include causing service of engine 100 and/or piston 200 to be automatically scheduled. Additionally, or alternatively, the remedial action may include may modify an operation of engine 100. For example, ECM 320 may cause engine 100 to slow down, decelerate, and/or be shut down to prevent additional damage to piston 200.

In some implementations, each remedial action described above may be associated with a respective amount of wear of piston ring 292 (with each amount of wear corresponding to a respective level of severity of damage to piston ring 292, piston 200, and/or engine 100). Accordingly, ECM 320 may select a remedial action based on the amount of wear of piston ring 292.

As further shown in FIG. 4, if the damage count does not exceed the piston ring damage threshold (block 460—NO), then process 400 may return to block 410. In some implementations, if the damage count does not exceed the piston ring damage threshold (block 460—NO), then process 400 may return to any one of block 410, block 420, block 430, block 440, or block 450. In some implementations, with respect to block 420, the piston ring wear rate may vary over a period of time based on the wear of piston ring 292. Accordingly, as explained above, ECM 320 may re-determine the piston ring wear rate each time ECM 320 determines the wear of piston ring 292.

### INDUSTRIAL APPLICABILITY

The disclosed system may be used in any application where an increase in reliability of an engine and components of an engine is desire. The disclosed system may increase engine reliability by monitoring and determining an amount of wear of a piston ring, determining an amount of damage to the piston ring based on the amount of wear, and taking a remedial action when the amount of damage exceeds a threshold. In some implementations, ECM 320 may determine the piston ring wear rate, the effective piston ring wear rate, the amount of wear of piston ring 292, and/or the amount of damage to piston ring 292 in real-time or near real-time. In some implementations, ECM 320 may predict a time (e.g., date and/or time) when engine 100 and/or piston 200 may begin experiencing damage and/or when engine 100 and/or piston 200 may begin experience a failure based on one or more factors (e.g., the piston ring wear rate, the effective piston ring wear rate, the amount of wear of piston ring 292, the amount of damage to piston ring 292, the time interval for ECM 320 to determine the amount of wear, the previous amount of wear, other information include in the piston ring wear information, a pattern of operation of engine 100, and/or the like). In this regard, as part of taking the remedial action, ECM 320 may cause information regarding the prediction to be displayed via display 330, may cause information indicating that engine 100 and/or piston 200 are to be serviced and/or replaced at or before the predicted time to be displayed via display 330, may cause engine 100 and/or piston 200 to replaced, cause a service of engine 100 and/or piston 200 to be scheduled, and/or the like.

The disclosed system may have broad applicability. In particular, the system may be applicable to any type and design of piston 200, and may be useful during design and/or selection of piston 200 prior to use of piston 200 within engine 100. For example, information associated with and performance parameters measured from an existing engine may be used by ECM 320 to simulate wear of an engine and components of the engine. The results of the simulation may then be used to design and/or select application-specific pistons. In addition, the system may provide information regarding the amount of damage to piston ring 292, and the information may remain accurate as engine 100 wears (as the piston ring wear information is updated based on wear conditions). In addition, the system may be useful across multiple configurations or platforms of engines. The disclosed concepts can be used during development of the engine components based on historic engine data, as desired. In particular, the disclosed concepts can be used to determine the status of the engine components given particular operating conditions. For example, based on a calculated amount of damage calculated for the engine components when exposed to the particular operating conditions, properties and/or geometry of the engine components can be changed so as to reduce the amount damage for the same components exposed to the same operating conditions.

It will be apparent to those skilled in the art that various modifications and variations can be made to the disclosed system. Other embodiments will be apparent to those skilled in the art from consideration of the specification and practice of the disclosed system. For example, it may be possible for engine 100 to not have cylinder liner 130, if desired, and for piston 200 to reciprocate directly within cylinder bores 120. Additionally, one or more of the parameters used to determine the amount of wear of piston ring 292 may vary based on one or more factors relating to piston 200 and/or engine 100, such as operating conditions, properties, shapes, sizes, contours, geometry, and/or the like. It is intended that the specification and examples be considered as exemplary only, with a true scope being indicated by the following claims and their equivalents.

No element, act, or instruction used herein should be construed as critical or essential unless explicitly described as such. While the present disclosure has been referring to monitoring or determining wear of a piston ring of a piston of an engine, one skilled in the art would appreciate that the present disclosure may similarly apply to monitoring or determining wear of one or more other engine components (including one or more of the engine components of engine 100 described above). In this regard, any reference to engine 100 may refer to engine 100 as a whole and/or one or more components of engine 100. Similarly, any reference to piston 200 may refer to piston 200 as a whole and/or one or more components of piston 200. Also, as used herein, the articles “a” and “an” are intended to include one or more items, and may be used interchangeably with “one or more.” Furthermore, as used herein, the term “set” is intended to include one or more items, and may be used interchangeably with “one or more.” Moreover, as used herein, the “reduction of the initial dimension of coating” and the “reduction in the thickness of coating” may be used interchangeably to refer to coating wear, face wear, coating thickness wear, and/or the like. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A control system for monitoring an amount of wear of a piston ring of a piston of an engine, the control system comprising:
a sensor configured to detect a cylinder pressure associated with the piston;
a memory configured to store piston ring wear information; and
an electronic control module configured to:
obtain, from the piston ring wear information stored in the memory, information identifying a previous amount of wear of the piston ring and information identifying an initial thickness of a coating of the piston ring;
determine a piston ring wear rate based on the cylinder pressure;
determine an amount of time between a current time and a time when the previous wear of the piston ring was calculated;
calculate a current amount of wear of the piston ring based on the previous amount of wear of the piston ring, the amount of time, and the piston ring wear rate;
calculate an amount of damage to the piston ring based on the current amount of wear of the piston ring and the initial thickness; and
take a remedial action based on the amount of damage to the piston ring.

2. The control system of claim 1, wherein the piston ring wear rate varies based on a reduction in a thickness of the coating.

3. The control system of claim 1, wherein the current amount of wear of the piston ring is based on an amount of reduction of the initial thickness.

4. The control system of claim 1, wherein the electronic control module is further configured to:
determine whether the amount of damage to the piston ring exceeds a piston ring damage threshold, and
take the remedial action when the amount of damage to the piston ring exceeds the piston ring damage threshold.

5. The control system of claim 1, wherein the electronic control module is configured to calculate an effective piston ring wear rate based on the piston ring wear rate and a wear rate modifier.

6. The control system of claim 5, wherein the electronic control module is configured to calculate the current amount of wear of the piston ring based on the previous amount of wear of the piston ring, the amount of time, and the effective piston ring wear rate.

7. The control system of claim 1, further comprising a display,
wherein, when taking the remedial action, the electronic control module is configured to cause information to be displayed via the display, and
wherein the information, displayed to the user, includes:
information indicating that the amount of damage to the piston ring has exceeded the piston ring damage threshold and that the piston is to be damaged or is to fail if the piston continues to be used.

8. The control system of claim 1, further comprising a display,
wherein, when taking the remedial action, the electronic control module is configured to cause information to be displayed via the display,
wherein the information, displayed to the user, includes at least one of:
information indicating that the engine is to be shut down or derated to prevent additional wear of the piston pin bore,
information indicating that the engine is to be serviced, or
information indicating that the piston is to be serviced of replaced.

9. The control system of claim 1, wherein, when taking the remedial action, the electronic control module is configured to modify an operation of the engine, and
wherein, when taking the remedial action, wherein, when modifying the operation of the engine, the electronic control module is configured to at least one of:
cause the engine to decelerate, or
cause the engine to shut down.

10. A method for monitoring an amount of wear of a piston ring of a piston of an engine, the method comprising:
detecting, by a sensor, a cylinder pressure associated with the piston;
obtaining, by an electronic control module and from piston ring wear information stored in a memory, information identifying a previous amount of wear of the piston ring and information identifying an initial thickness of a coating of the piston ring;
determining, by the electronic control module, a piston ring wear rate based on the cylinder pressure;
determining, by the electronic control module, an amount of time between a current time and a time when the previous wear of the piston ring was calculated;
calculating, by the electronic control module, a current amount of wear of the piston ring based on the previous amount of wear of the piston ring, the amount of time, and the piston ring wear rate;
calculating, by the electronic control module, an amount of damage to the piston ring based on the current amount of wear of the piston ring and the initial thickness; and
taking, by the electronic control module, a remedial action based on the amount of damage to the piston ring.

11. The method of claim 10, wherein the piston ring wear rate decreases based on a reduction in a thickness of the coating.

12. The method of claim 10, wherein the current amount of wear of the piston ring is based on an amount of reduction of the initial thickness.

13. The method of claim 10, further comprising:
determining whether the amount of damage to the piston ring exceeds a piston ring damage threshold; and
taking the remedial action when the amount of damage to the piston ring exceeds the piston ring damage threshold.

14. The method of claim 10, further comprising calculating calculate an effective piston ring wear rate based on the piston ring wear rate and a wear rate modifier.

15. The method of claim 10, further comprising calculating the current amount of wear of the piston ring based on the previous amount of wear of the piston ring, the amount of time, and the piston ring wear rate.

16. The method of claim 10, wherein taking the remedial action includes causing information to be displayed to a user,
wherein the information, displayed to the user, includes at least one of:
information indicating that the amount of damage to the piston ring has exceeded the piston ring damage threshold and that the piston is to fail if the piston continues to be used,
information indicating that the engine is to be shut down or derated to prevent additional damage to the piston ring,
information indicating that the engine is to be serviced, or
information indicating that the piston is to be serviced of replaced.

17. The method of claim 10, wherein taking the remedial action includes modifying an operation of the engine, and
wherein modifying the operation of the engine includes at least one of:
causing the engine to decelerate, or
causing the engine to shut down.

18. A machine comprising:
a piston;
a memory configured to store piston ring wear information; and
an electronic control module configured to:
obtain, from the piston ring wear information stored in the memory, information identifying a previous amount of wear of the piston ring and information identifying an initial dimension of a coating of the piston ring;
determine a piston ring wear rate based on a cylinder pressure associated with the piston;
determine an amount of time between a current time and a time when the previous wear of the piston ring was calculated;
calculate a current amount of wear of the piston ring based on the previous amount of wear of the piston ring, the amount of time, and the piston ring wear rate;
calculate an amount of damage to the piston ring based on the current amount of wear of the piston ring and the initial dimension; and
take a remedial action when the amount of damage to the piston ring exceeds a piston ring damage threshold.

19. The machine of claim 18, wherein the piston ring wear rate varies based on a reduction in a dimension of the coating, and
wherein the current amount of wear of the piston ring is based on an amount of reduction of the initial dimension.

20. The machine of claim 18, wherein, when taking the remedial action, the electronic control module is configured to at least one of:
modify the operation of the engine, or
cause information to be displayed via a display of the machine,
wherein the information, displayed via the display, includes at least one of:
information indicating that the amount of damage to the piston ring has exceeded the piston ring damage threshold,
information indicating that the engine is to be shut down or derated,
information indicating that the engine is to be serviced, or
information indicating that the piston is to be serviced of replaced.
